(19) United States
(12) Patent Application Publication
(10) Pub. No.: US 2014/0164800 A1
(43) Pub. Date: Jun. 12, 2014

(54) ELECTRONIC DEVICE WITH OPERATING FREQUENCY ADJUTING FUNCTION AND METHOD FOR ADJUSTING OPERATING FREQUENCY

(71) Applicant: HON HAI PRECISION INDUSTRY CO., LTD., New Taipei (TW)

(72) Inventor: YAO-TING CHANG, New Taipei (TW)

(73) Assignee: HON HAI PRECISION INDUSTRY CO., LTD., New Taipei (TW)

(21) Appl. No.: 14/080,769

(22) Filed: Nov. 14, 2013

(30) Foreign Application Priority Data
Dec. 7, 2012 (TW) 101145996

(51) Int. Cl. G06F 1/32

(52) U.S. Cl. CPC G06F 1/3206
USPC 713/322

(57) ABSTRACT

The present invention provides an electronic device with operating frequency adjusting function. The electronic device detects the inner temperature value T0 of the electronic device and the power consumption W0 of an electronic component of the electronic device. The electronic device determines whether a trigger condition is met according to the detected inner temperature value T0 and the detected power consumption W0 of the electronic component, determines the adjusting schedule corresponding to the trigger condition determined to be met, and adjusts the operating frequency of the electronic component according to the determined adjusting schedule.

### BACKGROUND

1. Technical Field

The present disclosure relates to electronic devices, and particularly, to an electronic device capable of automatically adjusting operating frequency and a method for automatically adjusting operating frequency.

2. Description of Related Art

Usually, when the temperature of a central processing unit (CPU) exceeds a preset value, the operating frequency of the CPU is decreased to decrease the temperature of the CPU. However, when the temperature of the CPU has already exceeded the preset power value, the electronic device may break down or electronic components of the electronic device may be damaged, and it may be meaningless to decrease the operating frequency of the CPU at this point. Therefore, it is desired to provide a method to prevent the temperature of the CPU from becoming too high to protect the electronic device.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of an electronic device with operating frequency adjusting function, in accordance with an exemplary embodiment.

FIG. 2 is a flowchart of a method for adjusting operating frequency of the electronic device of FIG. 1, in accordance with an exemplary embodiment.

### DETAILED DESCRIPTION

Embodiments of the present disclosure are now described in detail, with reference to the accompanying drawings.

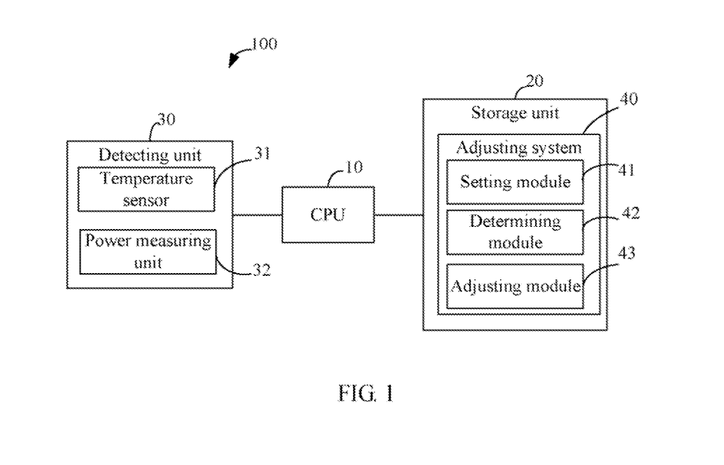

FIG. 1 shows an embodiment of an electronic device 100 with operating frequency adjusting function. The electronic device 100 adjusts the operating frequency of an electronic component of the electronic device 100 according to the inner temperature value of the electronic device 100 and the power consumption W0 of the electronic component. In this embodiment, the electronic component is a CPU 10. The electronic component may be a storage unit 20. In this embodiment, the electronic device 100 includes the CPU 10, the storage unit 20, and a detecting unit 30. The storage unit 20 stores a number of modules of an adjusting system 40. The adjusting system 40 includes a setting module 41, a determining module 42, and an adjusting module 43. The CPU 10 executes the number of modules of the adjusting system 40 to perform functions of the electronic device 100.

The setting module 41 responds to user input to set one or more trigger conditions for triggering the electronic device 100 to adjust the operating frequency of the CPU 10, set one or more adjusting schedule each corresponding to one trigger condition, and store the trigger conditions and the adjusting schedules to the storage unit 20. Each trigger condition consists of the inner temperature value of the electronic device 100 and the power consumption W0 of the CPU 10. In this embodiment, the trigger conditions includes a first trigger condition, a second trigger condition, and a third trigger condition. The first trigger condition is that the inner temperature value T0 falls within a first temperature range T1-T2, and the power consumption W0 of the CPU 10 reaches or exceeds a first preset power consumption W1. The second trigger condition is that the inner temperature value T0 falls within a second temperature range T2-T3 and the power consumption W0 reaches or exceeds a second preset power consumption W2. The third trigger condition is that the inner temperature value T0 falls within a third temperature range T>T3, and the power consumption W0 reaches or exceeds a third value W3. The first preset power consumption W1 is greater than the second preset power consumption W2, and the second preset power consumption W2 is greater than the third preset power consumption W3. In this embodiment, the inner temperature value T0 that falls within one preset temperature range includes the inner temperature value T0 that is equals to the lower limit and upper limit of the preset temperature range. The temperature value T1 is 30° C., the temperature value T2 is 35° C., and the temperature value T3 is 40° C. The first preset power consumption W1 is 90 W, the second preset power consumption W2 is 85 W, and the third preset power consumption is 80 W. In the illustrated embodiment, when any of the trigger conditions is met, the temperature value of the CPU 10 will not be too high, and the electronic device 100 can operate normally. In this embodiment, the adjusting schedules include a first adjusting schedule, a second adjusting schedule, and a third adjusting schedule. The first adjusting schedule corresponding to the first trigger condition is to decrease the operating frequency of the CPU 10 a first percentage. The second adjusting schedule corresponding to the second trigger condition is to decrease the operating frequency of the CPU 10 a second percentage. The third adjusting schedule corresponding to the third trigger condition is to decrease the operating frequency of the CPU 10 a third percentage. The first, second, and third percentage may be the same or different.

The storage unit 20 stores the one or more trigger conditions and adjusting schedules. In another embodiment, the setting module 41 can be absent from the electronic device 100. The one or more trigger conditions and adjusting schedules are preset by the manufacturer of the electronic device 100.

The detecting unit 30 detects the inner temperature value T0 of the electronic device 100 and the power consumption W0 of the CPU 10. In this embodiment, the detecting unit 30 includes a temperature sensor 31 sensing the inner temperature value, in addition, includes a power measuring unit 32 to measure the power consumption W0 of the CPU 10.

The determining module 42 determines whether one trigger condition is met according to the inner temperature value and the power consumption W0 of the CPU 10. For example, when the inner temperature value falls within the first temperature range T1-T2, and the power consumption W0 exceeds the first preset power consumption W1, the determining module 42 determines that one trigger condition is met.

The adjusting module 43 determines one adjusting schedule corresponding to the trigger condition determined to be met according to the relationship between the adjusting schedules and the trigger conditions, and adjusts the operating frequency according to the determined adjusting schedule. In this embodiment, the inner temperature value and the power consumption W0 are simultaneously employed to determine to adjust the operating frequency of the CPU 10, as such the damage of the electronic device 100 can be avoided.

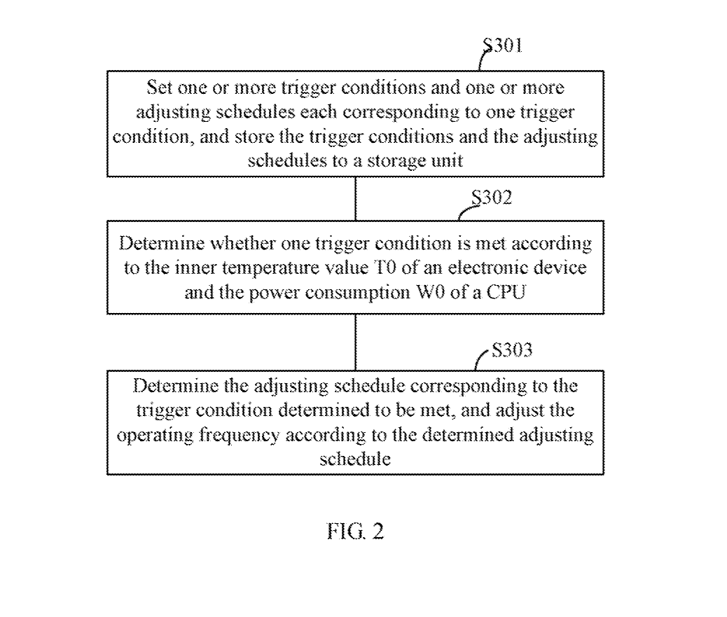

FIG. 2 is a flowchart of a method for adjusting the operating frequency of the electronic device 100, in accordance with an exemplary embodiment.

In step S201, the setting module 41 responds to user input to set one or more trigger conditions for triggering the electronic device 100 to adjust the operating frequency of the CPU 10, set one or more adjusting schedule each corresponding to one trigger condition, and store the trigger conditions and the adjusting schedules to the storage unit 20.

In step S202, the determining module determines whether one trigger condition is met according to the inner temperature value and the power consumption W0 of the CPU 10.

In step S203, the adjusting module 43 determines the adjusting schedule corresponding to the trigger condition determined to be met, and adjusts the operating frequency according to the determined adjusting schedule.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with operating frequency adjusting function, comprising:
a storage unit storing at least one trigger condition and at least one adjusting schedule each corresponding to one of the at least one trigger condition, each of the at least one trigger condition being consisted of a temperature range and a preset power consumption, the storage unit further storing a plurality of modules of an adjusting system;
a detecting unit to detect the inner temperature value T0 of the electronic device, and detect the power consumption W0 of an electronic component of the electronic device; and
a central processing unit to execute the plurality of modules of the adjusting system to perform operations of the electronic device, the operations comprising:
determining whether one of the at least one trigger condition is met according to the detected inner temperature value T0 and the detected power consumption W0 of the electronic component; and
determining the adjusting schedule corresponding to the one of the at least one trigger condition determined to be met, and adjusting the operating frequency of the electronic component according to the determined adjusting schedule.

2. The electronic device as described in claim 1, wherein the operations further comprising:
responding to user input to set the at least one trigger condition and the at least one adjusting schedule.

3. The electronic device as described in claim 1, wherein the at least one trigger condition comprises a first trigger condition, a second trigger condition, and a third trigger condition, the first trigger condition is that the detected inner temperature value falls with a first preset temperature range T1-T2, and the detected power consumption W0 reaches or exceeds a first preset power consumption W1, the second trigger condition is that the detected inner temperature value falls within a second preset temperature range T2-T3, and the detected power consumption W0 reaches or exceeds a second preset power consumption W2, and the third trigger condition is that the detected inner temperature value falls within a third preset temperature range T>T3, and the detected power consumption W0 reaches or exceeds the third preset power consumption W3, the first preset power consumption W1 is greater than the second preset power consumption W2, and the second preset power consumption W2 is greater than the third preset power consumption.

4. The electronic device as described in claim 3, wherein the temperature value T1 is 30° C., the temperature value T2 is 35° C., the temperature value T3 is 40° C., the first preset power consumption W1 is 90 W, the second preset power consumption W2 is 85 W, and the third preset power consumption is 80 W.

5. The electronic device as described in claim 3, wherein the at least one adjusting schedule comprises a first adjusting schedule, a second adjusting schedule, and a third adjusting schedule, the first adjusting schedule is to decrease the operating frequency of the electronic component a first preset percentage, the second adjusting schedule is to decrease the operating frequency of the electronic component a second preset percentage, and the third adjusting schedule is to decrease the operating frequency of the electronic component a third preset percentage.

6. The electronic device as described in claim 5, wherein the first preset percentage, the second preset percentage, and the third preset percentage are the same.

7. The electronic device as described in claim 5, wherein the first preset percentage, the second preset percentage, and the third preset percentage are different from each other.

8. The electronic device as described in claim 1, wherein the electronic component is the central processing unit of the electronic device.

9. A method for adjusting operating frequency of an electronic device, the electronic device comprising a storage unit storing at least one trigger condition and at least one adjusting schedule each corresponding to one of the at least one trigger condition, each of the at least one trigger condition being consisted of a temperature range and a preset power consumption, the electronic device further comprising a detecting unit to detect the inner temperature value T0 of the electronic device, and detect the power consumption W0 of an electronic component of the electronic device, the method comprising:
determining whether one of the at least one trigger condition is met according to the detected inner temperature value T0 and the detected power consumption W0 of the electronic component; and
determining the adjusting schedule corresponding to the one of the at least one trigger condition determined to be met, and adjusting the operating frequency of the electronic component according to the determined adjusting schedule.

10. The method as described in claim 9, further comprising:
responding to user input to set the at least one trigger condition and the at least one adjusting schedule.

11. The method as described in claim 9, wherein the at least one trigger condition comprises a first trigger condition, a second trigger condition, and a third trigger condition, the first trigger condition is that the detected inner temperature value falls with a first preset temperature range T1-T2, and the detected power consumption W0 reaches or exceeds a first preset power consumption W1, the second trigger condition is that the detected inner temperature value falls within a second preset temperature range T2-T3, and the detected power consumption W0 reaches or exceeds a second preset power consumption W2, and the third trigger condition is that the detected inner temperature value falls within a third preset temperature range T>T3, and the detected power consumption W0 reaches or exceeds the third preset power consumption W3, the first preset power consumption W1 is greater than the second preset power consumption W2, and the second preset power consumption W2 is greater than the third preset power consumption.

12. The method as described in claim 11, wherein the temperature value T1 is 30° C., the temperature value T2 is 35° C., the temperature value T3 is 40° C., the first preset power consumption W1 is 90 W, the second preset power consumption W2 is 85 W, and the third preset power consumption is 80 W.

13. The method as described in claim 11, wherein the at least one adjusting schedule comprises a first adjusting schedule, a second adjusting schedule, and a third adjusting schedule, the first adjusting schedule is to decrease the operating frequency of the electronic component a first preset percentage, the second adjusting schedule is to decrease the operating frequency of the electronic component a second preset percentage, and the third adjusting schedule is to decrease the operating frequency of the electronic component a third preset percentage.

14. A non-transitory storage medium storing a plurality of modules, the plurality of modules comprising instructions executable by a central processing unit of a computing device to perform an operating frequency adjusting method, the electronic device comprising a storage unit storing at least one trigger condition and at least one adjusting schedule each corresponding to one of the at least one trigger condition, each of the at least one trigger condition being consisted of a temperature range and a preset power consumption, the electronic device further comprising a detecting unit to detect the inner temperature value T0 of the electronic device, and detect the power consumption W0 of an electronic component of the electronic device, the method comprising:
determining whether one of the at least one trigger condition is met according to the detected inner temperature value T0 and the detected power consumption W0 of the electronic component; and
determining the adjusting schedule corresponding to the one of the at least one trigger condition determined to be met, and adjusting the operating frequency of the electronic component according to the determined adjusting schedule

15. The storage medium as described in claim 14, wherein the method further comprising:
responding to user input to set the at least one trigger condition and the at least one adjusting schedule.

16. The storage medium as described in claim 14, wherein the at least one trigger condition comprises a first trigger condition, a second trigger condition, and a third trigger condition, the first trigger condition is that the detected inner temperature value falls with a first preset temperature range T1-T2, and the detected power consumption W0 reaches or exceeds a first preset power consumption W1, the second trigger condition is that the detected inner temperature value falls within a second preset temperature range T2-T3, and the detected power consumption W0 reaches or exceeds a second preset power consumption W2, and the third trigger condition is that the detected inner temperature value falls within a third preset temperature range T>T3, and the detected power consumption W0 reaches or exceeds the third preset power consumption W3, the first preset power consumption W1 is greater than the second preset power consumption W2, and the second preset power consumption W2 is greater than the third preset power consumption.

17. The storage medium as described in claim 16, wherein the temperature value T1 is 30° C., the temperature value T2 is 35° C., the temperature value T3 is 40° C., the first preset power consumption W1 is 90 W, the second preset power consumption W2 is 85 W, and the third preset power consumption is 80 W.

18. The storage medium as described in claim 16, wherein the at least one adjusting schedule comprises a first adjusting schedule, a second adjusting schedule, and a third adjusting schedule, the first adjusting schedule is to decrease the operating frequency of the electronic component a first preset percentage, the second adjusting schedule is to decrease the operating frequency of the electronic component a second preset percentage, and the third adjusting schedule is to decrease the operating frequency of the electronic component a third preset percentage.

19. The storage medium as described in claim 18, wherein the first preset percentage, the second preset percentage, and the third preset percentage are the same.

20. The storage medium as described in claim 18, wherein the first preset percentage, the second preset percentage, and the third preset percentage are different from each other.
